(19) United States
(12) Patent Application Publication
(10) Pub. No.: US 2006/0192000 A1
(43) Pub. Date: Aug. 31, 2006

(54) Method for authenticating RUIM card

(76) Inventor: Ick Hee Cho, Seoul (KR)

Correspondence Address: FENWICK & WEST LLP, SILICON VALLEY CENTER, 801 CALIFORNIA STREET, MOUNTAIN VIEW, CA, 94041, US

(21) Appl. No.: 11/363,569

(22) Filed: Feb. 27, 2006

(30) Foreign Application Priority Data
Feb. 28, 2005 (KR) 10-2005-0016814

(51) Int. Cl. G06K 5/00

(52) U.S. Cl. 235/380

(57) ABSTRACT

A method for authenticating a RUIM card comprises: determining whether authentication process proceeds or not depending on identification of an external input code with an internal storage code; generating an authentication parameter with a RUIM identifier and an ESN (Electric Serial Number); generating a final authentication value with an authentication parameter group including the authentication parameter; and determining whether registration is successful or not depending on a message received in response to the final authentication value.

### CROSS-REFERENCE TO RELATED APPLICATION

This application claims priority under 35 U.S.C. §119(a) from Republic of Korea Patent Application No. 10-2005-0016814, filed on Feb. 28, 2005, which is incorporated by reference herein in its entirety.

### BACKGROUND OF THE INVENTION

1. Field of the Invention

The present invention generally relates to a method for authenticating a removable user identity module (hereinafter, referred to as “RUIM”) card, and more specifically, to a method for authenticating a RUIM card to prevent mixture of RUIM cards used in a radio terminal for home and a mobile communication terminal among portable terminals equipped with RUIM cards.

2. Description of the Related Art

FIG. 1 is a flow chart illustrating a conventional method for authenticating a RUIM card.

A microprocessor in a RUIM card reads a state of Card Holder Verification (hereinafter, referred to as “CHV”) stored in EEPROM in a RUIM card (S101) to judge whether the CHV is enabled, and finishes the process when the CHV is not enabled (S102). If the CHV is enabled, the microprocessor receives the CHV from a terminal user (S103). Thereafter, the microprocessor judges whether the CHV inputted from a user is identical with that stored in EEPROM in the RUIM card (S104). When the CHV inputted from a user is identical with that stored in EEPROM in the RUIM card, the microprocessor receives random numbers for authentication which are generated from a network (S105). Then, the microprocessor generates an authentication value with RUIM ID, IMSI (International Mobile Station Identity), SSD (Shared Secret Data) and the random numbers for authentication that are stored in EEPROM in the RUIM card (S106). Next, the microprocessor identifies which one of an authentication success message resulting from consistency of the authentication value and an authentication fail message resulting from inconsistency of the authentication value is received (S107). Since the reception of the authentication success message resulting from consistency of the authentication value is regarded as registration success, the microprocessor enables a portable terminal to provide service that a RUIM card user wants (S108). Since the reception of the authentication fail message resulting from inconsistency of the authentication value is regarded as registration fail, the process is finished (S109). Meanwhile, when the CHV inputted from a user is not identical with that stored in EEPROM in the RUIM card, the microprocessor judges whether a super code PUK is received. The microprocessor receives random numbers for authentication which are generated from a network (S105) when the super code PUK is received, and regards the process as registration fail (S109) when the super code PUK is not received.

However, according to the prior art, when a terminal user installs a RUIM card used in a radio terminal for home to a mobile communication terminal to input a super code PUK, it is not difficult to perform an authentication process. As a result, the RUIM card used in a radio terminal for home that requires a relatively inexpensive call charge can be installed in a mobile communication terminal that requires an expensive call charge, which results in confusion of the charge system.

### SUMMARY OF THE INVENTION

Various embodiments of the present invention are directed at providing a method for authenticating a RUIM card which comprises performing an authentication process with RUIM ID and an ESN (Electric Serial Number) to complement a locking method by a PIN (Private Identification Number) which is weak to a super code, thereby preventing the confusion of the charge system that results from installation of the RUIM card used in a radio terminal for home which requires an inexpensive call charge to a mobile communication terminal which requires an expensive call charge.

According to an embodiment of the present invention, a method for authenticating a RUIM card comprises: determining whether authentication process proceeds or not depending on identification of an external input code with an internal storage code; generating an authentication parameter with a RUIM identifier and an ESN (Electric Serial Number); generating a final authentication value with an authentication parameter group including the authentication parameter; and determining whether registration is successful or not depending on a message received in response to the final authentication value.

According to an embodiment of the present invention, a method for authenticating a RUIM card comprises: determining whether authentication process proceeds or not depending on identification of an external input code with an internal storage code; providing an ESN (Electric Serial Number) as an authentication parameter depending on reception of a message for requesting the ESN; and transmitting a final authentication value generated by an authentication parameter group including the authentication parameter to determine whether registration is successful or not depending on a message received in response to the final authentication value.

### BRIEF DESCRIPTION OF THE DRAWINGS

Other aspects and advantages of the present invention will become apparent upon reading the following detailed description and upon reference to the drawings in which:

FIG. 1 is a flow chart illustrating a conventional method for authenticating a RUIM card;

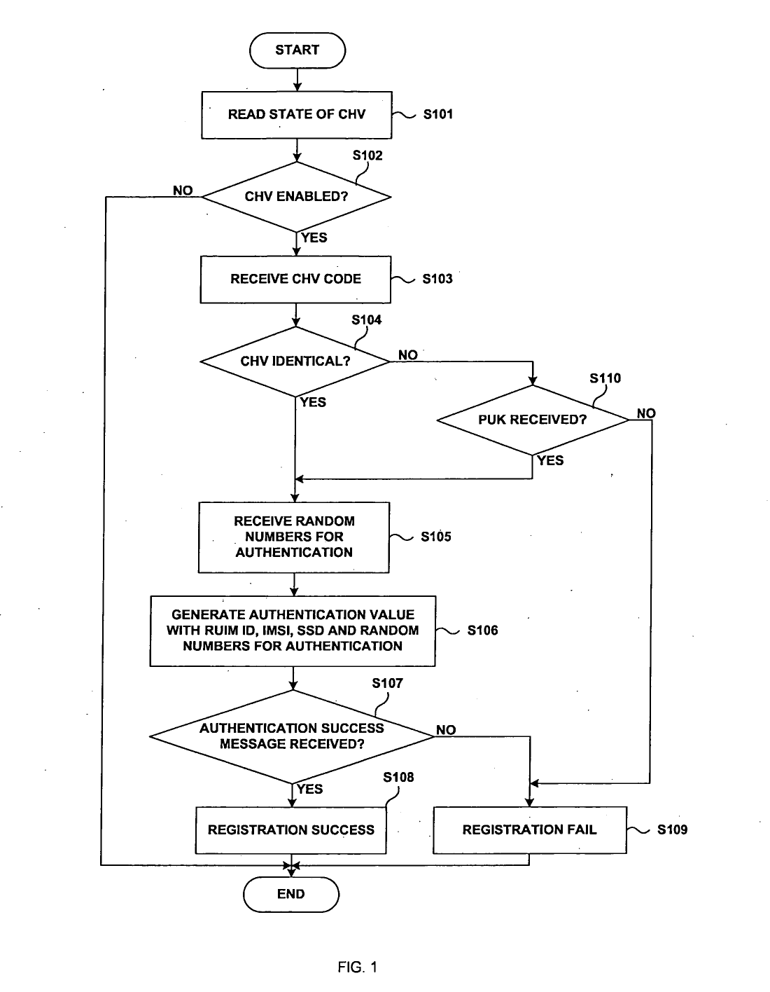

FIG. 2 is a block diagram illustrating a system applied with a method for authenticating a RUIM card according to an embodiment of the present invention;

FIG. 3 is a diagram illustrating an internal file structure stored in EEPROM of the RUIM card of FIG. 2;

FIG. 4 is a flow chart illustrating an operation for authenticating a RUIM card in the method for authenticating a RUIM card according to an embodiment of the present invention;

FIG. 5 is a flow chart illustrating an authentication operation of a terminal in the method for authenticating a RUIM card according to an embodiment of the present invention.

### DETAILED DESCRIPTION OF THE EXEMPLARY EMBODIMENTS

The present invention will be described in detail with reference to the accompanying drawings. Wherever possible, the same reference numbers will be used throughout the drawings to refer to the same or like parts.

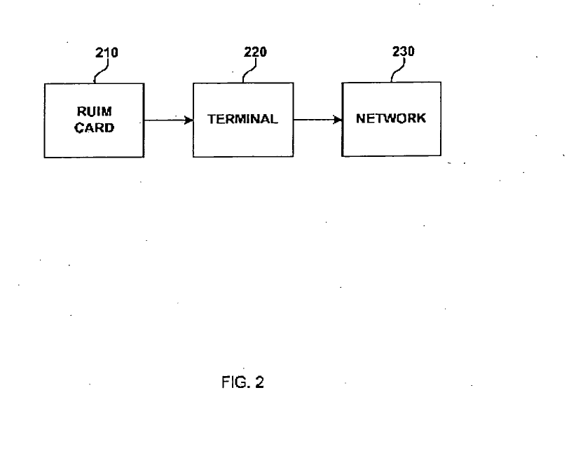

FIG. 2 is a block diagram illustrating a system applied with a method for authenticating a RUIM card according to an embodiment of the present invention.

In one embodiment of the present invention, the system comprises a RUIM card 210, a terminal 220, a network 230.

The RUIM card 210 generates an authentication parameter with RUIM ID and an Electric Serial Number (hereinafter, referred to as “ESN”), and then generates a final authentication value with an authentication parameter group including the authentication parameter. Also, the RUIM card 210 that comprises a microprocessor (not shown), a ROM (not shown), a RAM (not shown) and an EEPROM (not shown) stores identification information of subscribers and the ESN received from the terminal 220, and is removable from the terminal 220. Here, a command inputted from the terminal 220 is processed by the microprocessor and the ROM mounted in the RUIM card 210. A temporary variable is stored in the RAM mounted in the RUIM card 210, and a parameter used in the terminal 220 is stored in the EEPROM mounted in the RUIM card 210.

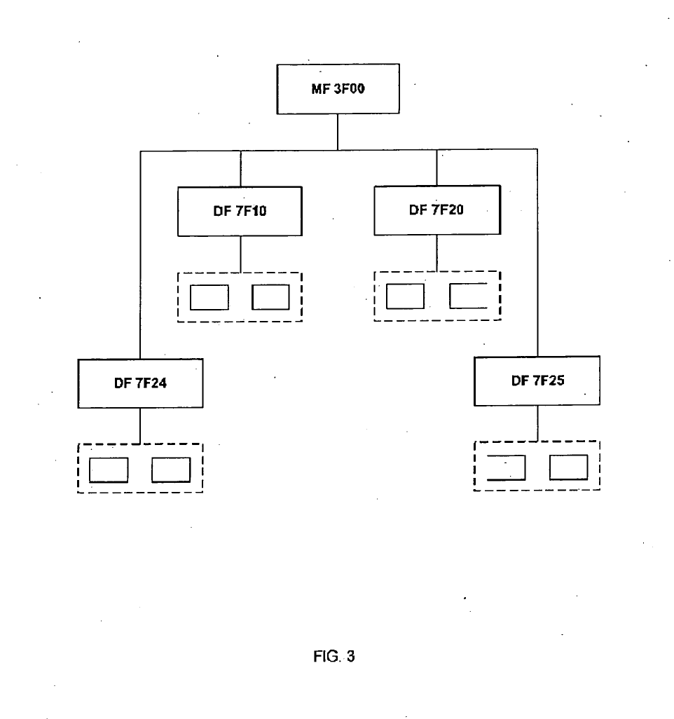

FIG. 3 is a diagram illustrating an internal file structure stored in the EEPROM of the RUIM card 210 of FIG. 2.

Referring to FIG. 3, a first address region (MF 3F00) in the EEPROM serves as a root of an internal file structure stored in the EEPROM, and stores authentication information such as CHV (Card Holder Verification).

A phone book and SMS (Short Message Service) are stored in a second address region (DF 7F10) in the EEPROM.

Meanwhile, a parameter for GSM such as a Mobile Identity Number (hereinafter, referred to as “MIN”) and RUIM ID is stored in a third address region (DF 7F20) in the EEPROM.

A parameter for TDMA such as a MIN and RUIM ID is stored in a fourth address region (DF 7F24) in the EEPROM.

A parameter for CDMA such as a MIN and RUIM ID is stored in a fifth address region (DF 7F25) in the EEPROM.

The terminal 220 that stores an ESN identifies whether a message for requesting provision of the ESN is received to provide the ESN as a parameter for authentication when the provision request message is received.

The network 230 that includes an authentication center compares an authentication value generated from the authentication center with a final authentication value generated from the RUIM card 210 to allow registration when they are the same.

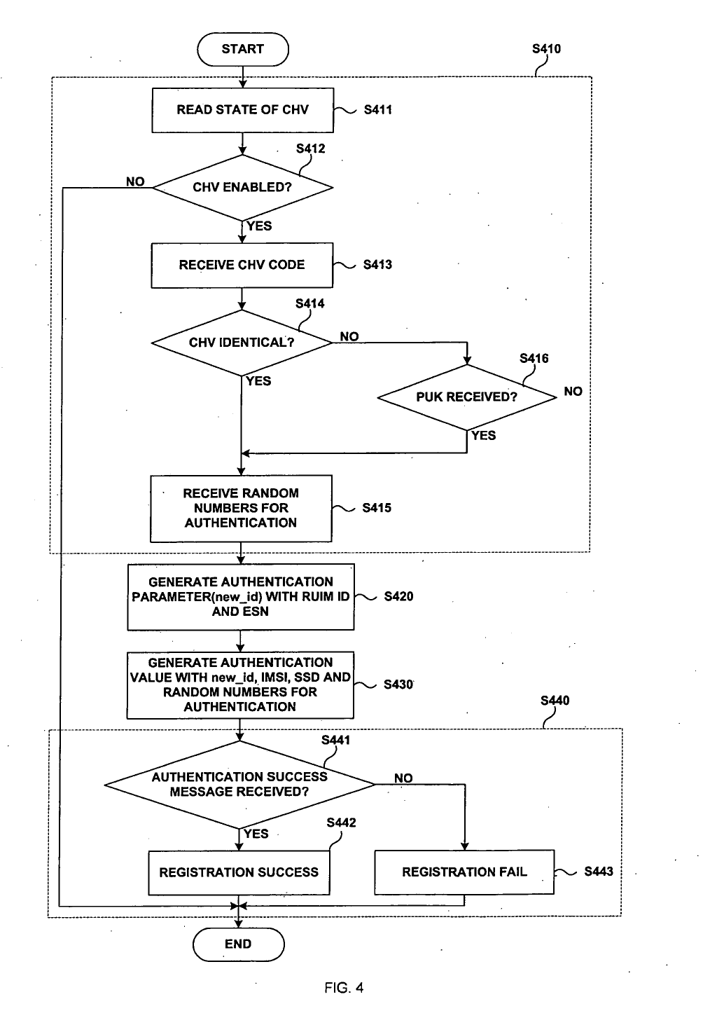

FIG. 4 is a flow chart illustrating an operation for authenticating the RUIM card 210 in the method for authenticating a RUIM card according to an embodiment of the present invention.

Whether authentication process proceeds or not is determined depending on identification of an internal storage code (e.g., CHV) stored in the EEPROM of the RUIM card 210 with an external input code inputted through a key input unit of the terminal 220 by a user (S410). Here, the step (S410) of determining whether authentication process proceeds or not is described in detail as follows.

The microprocessor in the RUIM card 210 reads a state of the CHV stored in the EEPROM of the RUIM card 210 (S411).

Thereafter, the microprocessor in the RUIM card 210 identifies whether the CHV stored in the EEPROM of the RUIM card 210 is enabled, and finishes the process when the CHV is not enabled (S412).

When the CHV is enabled, the microprocessor receives a CHV through the key input unit of the terminal 220 from a user (S413).

Thereafter, the microprocessor in the RUIM card 210 judges whether the CHV inputted from a user is identical with that stored in the EEPROM of the RUIM card 210 (S414).

When the CHV inputted from a user is identical with that stored in the EEPROM of the RUIM card 210, the microprocessor receives random numbers for authentication generated from the network 230 (S415).

Meanwhile, when the CHV inputted from a user is not identical with that stored in the EEPROM of the RUIM card 210, the microprocessor judges whether a super code PUK is received. The microprocessor receives random numbers for authentication which are generated from the network 230 (S415) when the super code PUK is received, and regards the process as registration fail (S443) when the super code PUK is not received (S416).

Then, the microprocessor in the RUIM card 210 generates an authentication parameter with the RUIM ID and ESN received from the terminal 220 (S420). Here, the embodiment on software of the step (S420) of generating an authentication parameter is as follows. The process of generating an authentication parameter is simultaneously performed also in the authentication center of the network 230.

```
mc_get_nv_item(NV_ESN_I, &mc_nv_data_buf);
Result = access( 3F00/7F25/6F43);
if (!Result) {
    access(RUIM_ID);
    access(ESN);
}
new_id = new_id_generator(RUIM_ID, ESN);
if (new_id) {
    cdma.esn_me = new_id;
} else {
    cdma.esn_me = 0;
}
```

mc_get_nv_item (NV_ESN_I, &mc_nv_data_buf) is an example of a routine function of accessing the ESN or RUIM ID to register the RUIM card 210 in the network 230. This function accesses the ESN or RUIM ID depending on a value stored in a predetermined address (e.g., 3F00/7F25/6F43) of an internal memory of the RUIM card 210.

Thereafter, the microprocessor in the RUIM card 210 generates a final authentication value with an authentication parameter group including the authentication parameter (S430). Here, the authentication parameter group may include IMSI (International Mobile Station Identity), SSD (Shared Secret Data) and random numbers for authentication as well as the authentication parameter. Although the process of generating the final authentication value is identical with the conventional one, misuse of the RUIM ID can be prevented with the above-described authentication parameter.

Next, the microprocessor in the RUIM card 210 determines whether registration is successful or not depending on a message received in response to the final authentication value (S440). Here, the step (S440) of determining whether registration is successful or not is described in detail as follows.

The microprocessor in the RUIM card 210 identifies which one of an authentication success message resulting from consistency of the authentication value and an authentication fail message resulting from inconsistency of the authentication value is received (S441). Since the reception of the authentication success message resulting from consistency of the authentication value is regarded as registration success, the microprocessor enables the portable terminal 220 to provide service that a RUIM card user wants (S442).

Since the reception of the authentication fail message resulting from inconsistency of the authentication value is regarded as registration fail, the process is finished (S443).

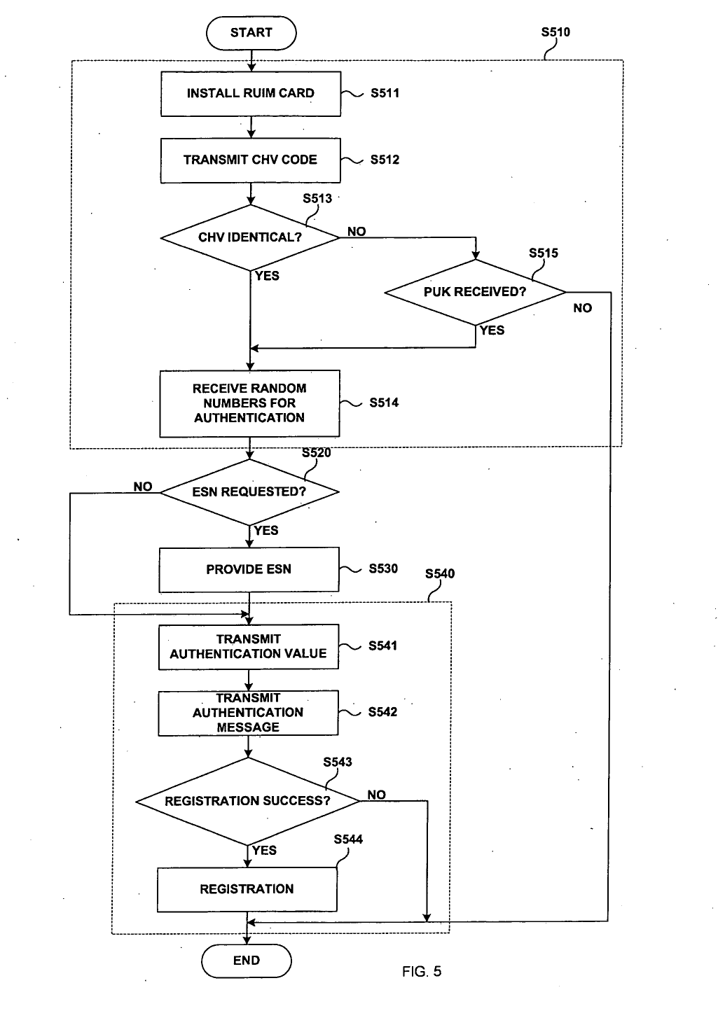

FIG. 5 is a flow chart illustrating an authentication operation of the terminal 220 in the method for authenticating a RUIM card according to an embodiment of the present invention.

The authentication process is performed depending on whether an internal storage code (e.g., CHV) stored in the EEPROM of the RUIM card 210 is identical with an external input code inputted through the key input unit of the terminal 220 by a user (S510). Here, the step (S510) of determining whether authentication process proceeds or not is described in detail as follows.

First, the RUIM card 210 is installed in the terminal 220 (S511).

The terminal 220 receives the CHV from the key input unit from a user to transmit the CHV into the RUIM card 210 (S512).

Then, the microprocessor in the RUIM card 210 judges whether the CHV stored in the EEPROM of the RUIM card 210 is identical with that inputted from the user so that the judgement result is recognized in the terminal 220 (S513).

When the CHV inputted from the user is identical with that stored in the EEPROM of the RUIM card 210, the terminal 220 receives random numbers for authentication that are generated from the network 230 to transmit the random numbers into the RUIM card 210 (S514).

Meanwhile, when the CHV inputted from the user is not identical with that stored in the EEPROM of the RUIM card 210, the terminal 220 judges whether the super code PUK is received from the key input unit. The step (S514) of receiving the random numbers for authentication generated from the network 230 is performed when the super code PUK is received, and the process is finished (S515) when the super code PUK is not received.

Thereafter, the terminal 220 judges whether a message for requesting provision the ESN from the RUIM card 210 is received (S520), and provides the ESN as a parameter for authentication when the provision request message is received (S530).

Next, a final authentication value generated by the authentication parameter group including the authentication parameter is transmitted, and whether registration is successful or not is determined depending on the message received in response to the final authentication value (S540). The step (S540) of determining whether registration is successful or not is described in detail as follows.

First, the terminal 220 transmits the final authentication value into the network. 230 (S541).

Then, the terminal 220 transmits the message received in response to the final authentication value into the RUIM card 210.

Thereafter, the terminal 220 regards the reception of the authentication success message resulting from consistency of the final authentication value (S543) as registration success. Thus, the portable terminal 220 provides service that a RUIM card user wants (S544).

The final authentication value is also generated in the authentication center of the network 230. The final authentication value for the authentication center is generated with application performed in the RUIM card 210, and compared with that of the RUIM card 210 which is transmitted through the terminal 220.

As a result, an authentication success message is generated when the final authentication values are the same, and an authentication fail message is generated when they are not the same, so that the messages are transmitted into the terminal 220.

As described above, according to a method for authenticating a RUIM card, an authentication process is performed with RUIM ID and an ESN to complement a locking method by a PIN (Private Identification Number) that is weak to a super code, thereby preventing confusion of the charge system that results from installation of the RUIM card used in a radio terminal for home which requires an inexpensive call charge to a mobile communication terminal which requires an expensive call charge.

The foregoing description of various embodiments of the invention has been presented for purposes of illustration and description. It is not intended to be exhaustive or to limit the invention to the precise form disclosed, and modifications and variations are possible in light of the above teachings or may be acquired from practice of the invention. Thus, the embodiments were chosen and described in order to explain the principles of the invention and its practical application to enable one skilled in the art to utilize the invention in various embodiments and with various modifications as are suited to the particular use contemplated.

What is claimed is:

1. A method for authenticating a RUIM card, the method comprising:
determining whether authentication process proceeds or not depending on identification of an external input code with an internal storage code;
generating an authentication parameter with a RUIM identifier and an ESN (Electric Serial Number);
generating a final authentication value with an authentication parameter group including the authentication parameter; and
determining whether registration is successful or not depending on a message received in response to the final authentication value.

2. The method according to claim 1, wherein the parameter generating step comprises selecting one of the RUIM identifier and the ESN to determine the selected one as the authentication parameter.

3. The method according to claim 2, wherein the parameter selecting step comprises:
analyzing a value stored in an address field for selecting a parameter in a RUIM card;
accessing a field where the RUIM identifier is stored or where the ESN is stored depending on an analysis value of the analysis step; and
obtaining a value stored in the accessed field of the access step.

4. The method according to claim 1, wherein the authentication parameter group further comprises IMSI (International Mobile Station Identity), SSD (Shared Secret Data) and random numbers for authentication.

5. A method for authenticating a RUIM card, the method comprising:
determining whether authentication process proceeds or not depending on identification of an external input code with an internal storage code;
providing an ESN (Electric Serial Number) as an authentication parameter depending on reception of a message for requesting the ESN; and
transmitting a final authentication value generated by an authentication parameter group including the authentication parameter to determine whether registration is successful or not depending on a message received in response to the final authentication value.

6. The method according to claim 5, wherein the authentication parameter group further comprises IMSI (International Mobile Station Identity), SSD (Shared Secret Data) and random numbers for authentication.
